(19) United States
(12) Patent Application Publication
(10) Pub. No.: US 2016/0343085 A1
(43) Pub. Date: Nov. 24, 2016

(54) CREATING AND DISTRIBUTING A PRINCIPAL GUARANTEE INSURANCE PRODUCT

(71) Applicant: COBBS, ALLEN & HALL, INC., Birmingham, AL (US)

(72) Inventors: Bradley Jon McGill, Birmingham, AL (US); Bruce Denson, Birmingham, AL (US)

(73) Assignee: COBBS, ALLEN & HALL, INC., Birmingham, AL (US)

(21) Appl. No.: 15/160,660

(22) Filed: May 20, 2016

Related U.S. Application Data
(60) Provisional application No. 62/165,706, filed on May 22, 2015.

(51) Int. Cl. G06Q 40/08; G06Q 40/06

(52) U.S. Cl. CPC G06Q 40/08; G06Q 40/06

(57) ABSTRACT

A computer-implemented method of managing risk in an investment portfolio, the method comprising: identifying an alternative asset vehicle, the alternative asset vehicle having a guarantee amount and an excess capital amount; issuing insurance on the alternative asset vehicle; and investing extra capital to maximize return. A system for managing capital for a commodity pool comprising a memory storage and a processing unit coupled to the memory storage. The processing unit is operable to: analyze a plurality of alternative asset vehicles, each alternative asset vehicle comprising a guarantee amount and an excess capital amount; display the excess capital amount for each alternative asset vehicle; and receive input to invest the excess capital amount for at least one of the alternative asset vehicles in a different investment vehicle.

This application is a non-provisional of provisional application Ser. No. 62/165,706 filed May 22, 2015, the entire disclosure of which is incorporated herein by reference in its entirety.

### TECHNICAL FIELD

This patent document generally relates to creating and distributing insurance products, and more particularly to creating and distributing a principle guarantee insurance product.

### BACKGROUND

A derivative instrument or product (derivative) is a tradable instrument or contract. Their value is derived from the price of some underlying asset and depends on such factors as the value of an underlying instrument, index, asset or liability, or on a feature of such an underlying instrument such as interest rates or convertibility into some other instrument. Financial futures on stock indices or options to buy and sell such futures contracts are highly popular exchange-traded financial derivatives. Derivatives may also be traded on commodities, insurance events, and other events, such as the weather.

Derivatives include futures contracts, futures on stock market indices, options and swaps, and can be used as a hedge to reduce risk, or for speculation.

A “listed” derivative is traded on exchanges, such as the option and futures contracts traded on the Chicago Mercantile Exchange, while an off-exchange or over-the-counter derivative is traded between two or more derivative counterparties. In order to enter into futures or options positions in the major exchanges an investor is required to deposit a collateral or margin requirement. This margin requirement is the initial deposit of “good faith” made into an account in order to enter into a futures contract. This margin is referred to as good faith because it is this money that is used to debit any day-to-day losses.

A commodity pool is an investment vehicle in which a number of individual investors combine their funds in one entity for the purposes of trading futures. Commodity pools are similar to mutual funds except for the fact that mutual funds invest in equity products and are publicly traded, where a commodity pool invests in futures products and are typically private structures.

When a commodity pool invests in a futures contract, the futures exchange will state a minimum amount of initial margin that the pool must deposit into their account. When the contract is liquidated, the exchange clearing house will reimburse this initial margin plus or minus any gains or losses that occur over the span of the futures contract. The level of margin is determined by the futures exchange and is usually 5% to 10% of the value of the futures contract. For example, one crude oil futures contract traded on the Chicago Mercantile Exchange represents an investment in 1,000 barrels of crude oil and the margin requirement set by the exchange is $4,500. If the price at which oil is trading is $45.00, then a single futures contract would be representing an investment in $45,000 worth of oil, but the exchange clearinghouse would only require you to have $4,500 in the account.

Principal protected investments are investments in a financial contract that during a predetermined period of time has a guaranteed rate of return of at least the amount invested, and a possible gain. The return the investor should receive at the end of the contracted period depends on a variety of circumstances already established by the investment contract. But in any case, the investor has the guarantee he will at least receive the initial capital investment.

The last decade has marked a period of time in the capital markets where volatile market conditions motivated many investors to actively seek investment vehicles that could offer the potential for growth, while preserving capital during rainy days.

In spite of the fact that the stock market has the ability to provide substantial upside, an equities portfolio is generally subject to a substantial risk of capital loss. On the other hand, while traditional fixed income products such as bonds are acceptable capital preservation vehicles they historically have provided very modest returns.

Principal protected notes (PPNs) were first introduced during the early 2000s as a result of investors looking for investment vehicles that would provide the potential of meaningful growth while guaranteeing the capital invested. A principal characteristic of a PPN is that it includes a guarantee, usually 100% of invested capital, as long as the note is held to maturity. At maturity, the payout on the PPN is typically the original principal in addition to any appreciation generated by the underlying assets specified in the terms of the PPN (usually an index, a basket of securities, a mutual fund etc.). At the end of the contracted period investors will at least receive the money initially invested, even if the underlying asset declined during that period.

PPNs and other type of guaranteed investments are constructed by depositing a substantial portion of the assets in fixed income products, while risking a smaller portion of the assets. For the sake of an example let's assume that an investor has $100,000 to invest in a principal guarantee investment that will mature at the end of 5 years. In addition, suppose that at that time the interest rate on the 5 year US Treasury Note is 4.00%. The effective 5 year return of an investment subjected to a 4% compounded annual rate would be approximately 21.66%.

That allows the portfolio manager to invest $82,192.71 in a 5 Year Treasury Bond and achieve $100,000 by the time the PPN reaches maturity. With this investment the offeror of the PPM guarantees that the investor will receive at least the $100,000 initial capital. In turn, the remaining $17,807.29 of capital can be invested in a very risky asset because even if all the capital was lost, the investor would receive its initial capital back at the end of the 5 year period. What usually happens is that the “freed” capital is invested in buying financial call options on the underlying asset that will largely rise in value when the underlying asset increases.

These types of investments are indeed attractive during times in which the interest rates are moderately high. The problem is that for the last several years the US Federal Reserve Bank has created a historical low interest rate environment. As of the end of January 2015 the 5 year note is yielding 1.37%. These levels of interest rates render the traditional mechanisms to provide principal guaranteed notes almost obsolete. As a result, the market is currently not seeing these types of investments being offered.

A method and system that creates, issues, and manages an investment vehicle that can be delivered in any type of interest rate environment, can generate the upside growth of an equity index, or other assets, and still guarantee the initial capital of the investment at the maturity date, would provide a large competitive advantage over competitive systems; specially during times where the interest rates were low.

### SUMMARY

One aspect of this patent document is a computer-implemented method of managing risk in an investment portfolio, the method comprising: identifying an alternative asset vehicle, the alternative asset vehicle having a guarantee amount and an excess capital amount; issuing insurance on the alternative asset vehicle; and investing extra capital to maximize return.

Another aspect is a system for managing capital for a commodity pool comprising a memory storage and a processing unit coupled to the memory storage. The processing unit is operable to: analyze a plurality of alternative asset vehicles, each alternative asset vehicle comprising a guarantee amount and an excess capital amount; display the excess capital amount for each alternative asset vehicle; and receive input to invest the excess capital amount for at least one of the alternative asset vehicles in a different investment vehicle.

### DESCRIPTION OF THE DRAWINGS

FIG. 1 is a flowchart illustrating the method of creating, issuing and managing an insurance policy that serves as an insurance underwritten guarantee of the principal value of commodity pools and other alternative asset vehicles.

FIG. 2 is a functional block diagram illustrating the method of creating, issuing and managing an insurance policy that serves as an insurance underwritten guarantee of the principal value of commodity pools and other alternative asset vehicles.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments.

This patent document relates to a method and system that supports the creation and distribution of an insurance policy that serves as an insurance underwritten guarantee of the principal value of commodity pools and other alternative asset vehicles. The method involves the collaboration of different market participants to create, distribute and maintain the insurance policy. These participants may include all or a combination of the following: an alternative asset vehicle, an operator of the alternative asset vehicle, a registered regulated manager of the alternative asset vehicle, an insurance broker, a program developer and insurance brokerage distribution channel, an investment bank, an insurance dealer, an insurance carrier, and a reinsurance company. The method also involves a machine readable medium that identifies, measures and reports any excess capital available in the alternative vehicle to all participants in the process, and at times establishes the flow of capital between all participants.

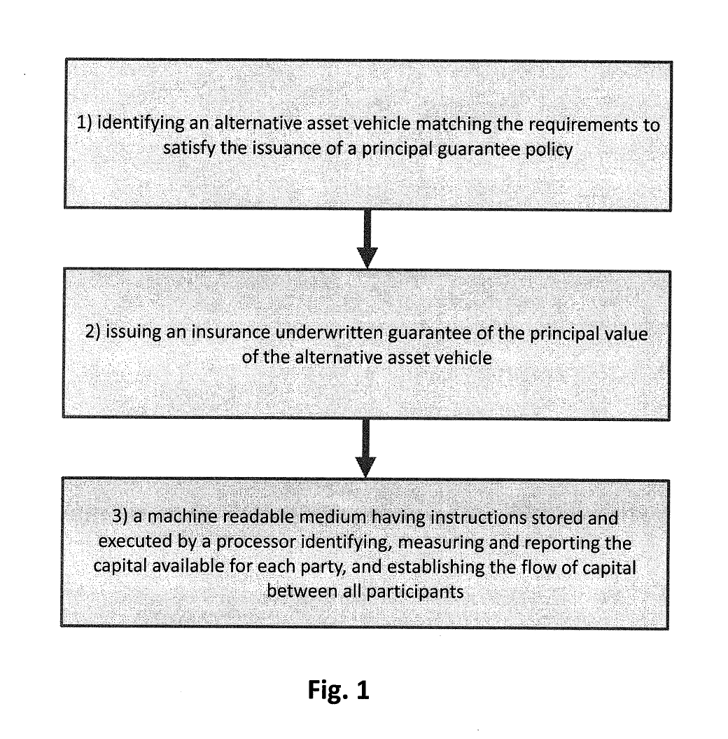

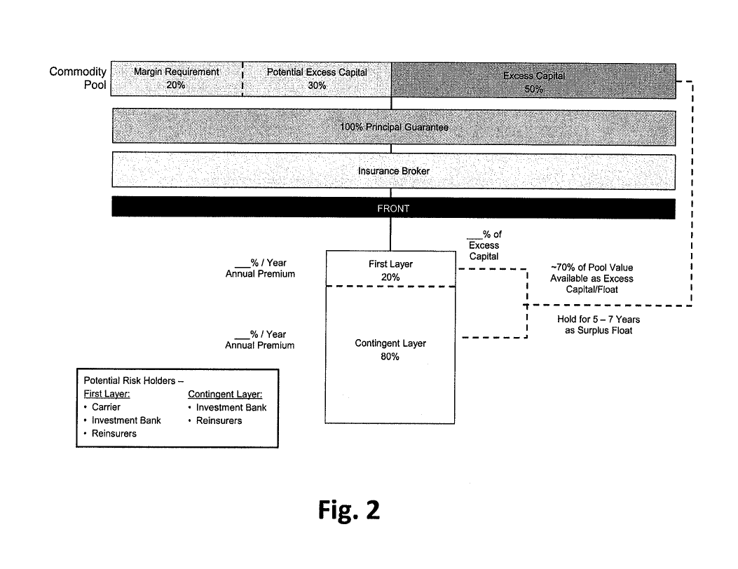

As illustrated in FIGS. 1 and 2, an alternative asset vehicle that fulfills certain requirements to satisfy the issuance of a principal guarantee policy is identified at operation 1. An example of an alternative asset vehicle is a commodity pool that may be established when the principal guarantee insurance policy issues, although other alternative asset vehicles are possible. A commodity pool typically generates its returns by investing in futures. As mentioned above, when a commodity pool invests in a futures contract, it will only have to deposit a small amount of money to maintain the level of margin required by the exchange. The level of margin is determined by the futures exchange and is usually 5% to 10% of the value of the futures contract.

The alternative asset vehicle is managed by an operator which invests the available funds into different futures strategies, solicits funds for the investment vehicle and is registered and regulated by the appropriate regulatory body. In the case of a commodity pool the operator of the pool is required to register with the National Futures Association as the individual or organization operating and soliciting funds for that commodity pool. The operator uses the machine medium as described in operation 3 to monitor and manage the investment program's exposure within the limits of the cash they have available to invest.

In operation 2, an insurance policy that serves as the insurance underwritten guarantee of the principal value of the alternative asset vehicle at the end of the duration of the investment pool is created and issued. This insurance policy has a term set at a predetermined period of time and is designed to pay for any cumulative losses incurred by the alternative investment vehicle when the policy term expires at the end of the predetermined period time. Upon expiration of the insurance policy, the alternative asset vehicle may need to renew the policy to continue the with the guarantee coverage.

In return for the guarantee, the alternative asset vehicle agrees to transfer a specified portion of the excess funds not needed as either initial or maintenance margin collateral to conduct its regular trading activities.

The insurance policy may be issued by any insurance carrier, including a major insurance carrier with a high credit rating. A high credit rating ensures the commodity pool is not exposed to substantial credit risk in case the insurance policy is triggered. In at least some embodiments, the insurance policy may be issued by one insurance carrier that guarantees 100% of the total initial capital available in the pool. In alternative embodiments, several insurance policies are issued representing two or more levels of risk, or an insurance policy is issued in two or more tranches representing different levels of risk. An insurance carrier can use different risk inputs to identify and split the potential loss into different tranches with different exposures and return characteristics. For example, one insurance carrier could choose to insure the first 20% cumulative maximum loss for the duration of the pool, and a second carrier could insure the remainder 80% cumulative maximum loss at the end of the duration of the pool.

The insurance policy can include various terms such as the type of policy, coverage summary, primary carrier, size of the investment pool, duration of the pool, premium amount, reinsurance terms, maximum loss exposures, risk management conditions, brokerage commissions, excess float, cost of funding agreement guarantee, along with conditions for distribution of profits on excess float by carrier. The insurance can be sold to the alternative asset vehicle by a third party insurance broker. Alternatively, the insurance carrier issuing the policy may sell the insurance policy directly to the investment pool.

As illustrated in operation 3, a machine readable medium having instructions stored and executed by a processor identifies, measures and reports the excess capital available in the alternative vehicle not needed for trading. This machine readable medium, stores the terms of one or more insurance policies and establishes the flow of capital between each participant of the process. In an exemplary embodiment, the machine receives capital balance information from the alternative asset vehicle on a daily basis to compute among other things information including, but not limited to, the amount of margin requirements, excess capital available, cumulative performance of the alternative investment vehicle, cumulative losses to date by the alternative investment vehicle as applicable, days to maturity of the policy, and amounts owed by which party expected payouts. The machine readable medium then values the amount of capital to support the investment pool along with the amount of excess capital available and then establishes the flow of capital between all participants. At the end of the duration period of the policy, the machine readable medium compares the net asset value of the alternative asset vehicle at that date to the net asset value at its inception date. In the case the net asset value at the maturity date is lower than the net asset value at inception, the machine readable medium issues a payment request to each carrier identifying the portion of the payout they are obligated to cover.

Accordingly, a method for supporting the creation and distribution of an insurance policy that serves as an insurance underwritten guarantee of the principal value of an alternative asset vehicles comprises: identifying an alternative asset vehicle that fulfills certain requirements to satisfy the issuance of a principal guarantee policy; creating and issuing an insurance policy that will serve as the insurance underwritten guarantee of the principal value of the alternative asset vehicle at the end of the duration of the investment; and a machine readable medium having instructions stored and executed by a processor identifying, measuring and reporting the capital available for each party, and establishing the flow of capital between all participants.

What is claimed is:

1. A computer-implemented method of managing risk in an investment portfolio, the method comprising:
identifying an alternative asset vehicle, the alternative asset vehicle having a guarantee amount and an excess capital amount;
issuing insurance on the alternative asset vehicle; and
investing extra capital to maximize return.

2. The method of claim 1 wherein the alternative asset vehicle is a commodity pool.

3. The method of claim 2 wherein the commodity pool:
invests in futures; and
maintains an initial deposit based on the value of the futures contract.

4. The method of claim 1 wherein the insurance policy has a set term based on a life of the alternative asset vehicle.

5. The method of claim 1 wherein the insurance policy has first level of risk, and wherein the method further comprises:
issuing a second insurance policy on the alternative asset vehicle, the second insurance policy having a second level of risk.

6. The method of claim 1 wherein the insurance policy includes two or more of the following terms: the type of policy, coverage summary, primary carrier, size of the investment pool, duration of the pool, premium amount, reinsurance terms, maximum loss exposures, risk management conditions, brokerage commissions, excess float, cost of funding agreement guarantee, and conditions for distribution of profits on excess float by carrier.

7. A system for managing capital for a commodity pool comprising:
a memory storage;
a processing unit coupled to the memory storage, wherein the processing unit is operable to:
analyze a plurality of alternative asset vehicles, each alternative asset vehicle comprising a guarantee amount and an excess capital amount;
display the excess capital amount for each alternative asset vehicle; and
receive input to invest the excess capital amount for at least one of the alternative asset vehicles in a different investment vehicle.

8. The system of claim 7 further comprising:
receive information related to an insurance policy on the plurality of alternative asset vehicles.

9. The system of claim 7 wherein the commodity pool invests in futures and maintains an initial deposit based on the value of the futures contract.

10. The system of claim 8 wherein the insurance policy has a set term based on a life of the alternative asset vehicle.

11. The system of claim 8 wherein the insurance policy has first level of risk, and wherein the method further comprises:
issuing a second insurance policy on the alternative asset vehicle, the second insurance policy having a second level of risk.

12. The system of claim 8 wherein the insurance policy includes two or more of the following terms: the type of policy, coverage summary, primary carrier, size of the investment pool, duration of the pool, premium amount, reinsurance terms, maximum loss exposures, risk management conditions, brokerage commissions, excess float, cost of funding agreement guarantee, and conditions for distribution of profits on excess float by carrier.
